(19) United States
(12) Patent Application Publication
(10) Pub. No.: US 2011/0032579 A1
(43) Pub. Date: Feb. 10, 2011

(54) Image forming apparatus, method for setting image-processing parameter, and computer program product

(75) Inventor: Akira MURAKATA, Kanagawa (JP)

Correspondence Address: Harness, Dickey & Pierce P.L.C., P.O. Box 8910, Reston, VA, 20195, US

(73) Assignee: RICOH COMPANY, LIMITED

(21) Appl. No.: 12/805,549

(22) Filed: Aug. 5, 2010

(30) Foreign Application Priority Data
Aug. 10, 2009 (JP) 2009-185775

(51) Int. Cl. H04N 1/00

(52) U.S. Cl. 358/403

(57) ABSTRACT

There is provided an image forming apparatus that includes: an operating unit; a plurality of scanner units each obtaining image data by scanning; an image processing unit capable of adjusting reading characteristics by correcting the image data; and an image-processing control unit that includes an image-processing-parameter calculating unit that calculates an image-processing parameter according to settings established via the operating unit, an image-processing-parameter storing unit that stores a calculation result, and an image-processing-parameter setting unit that sets the image-processing parameter stored in the image-processing parameter storing unit as an image-processing parameter of the image processing unit; and a difference-in-setting determining unit that makes a determination as to whether there is difference between previous settings and current settings established via the operating unit. The image-processing-parameter calculating unit includes a first calculating unit that calculates the image-processing parameter when the difference-in-setting determining unit has determined that there is the difference.

### CROSS-REFERENCE TO RELATED APPLICATIONS

The present application claims priority to and incorporates by reference the entire contents of Japanese Patent Application No. 2009-185775 filed in Japan on Aug. 10, 2009.

### BACKGROUND OF THE INVENTION

1. Field of the Invention

The present invention relates generally to image forming apparatus, method for setting image-processing parameter, and computer program product.

2. Description of the Related Art

Developments in imaging devices that use linear sensor formed from photoelectric converters, such as charge coupled devices (CCDs), and toner-image forming devices that utilize laser beams have brought about development of digital copiers that produce printouts of digitized image data from analog copiers.

Because digital copiers have greater affinity to other apparatuses that handle digital image data than analog copiers do, various functions, such as a facsimile function, a printer function, and a scanner function have come to be combined with digital copiers. Such digital copiers are generally referred to as digital multifunction peripherals (MFPs) rather than single-function digital copiers.

With increased capacity and reduction in price of memory, such as a hard disk drive (HDD), speedup and proliferation of network communications, enhanced processing power of central processing units (CPUs), and development of technologies related to MFPs, such as advancement in technologies (e.g., compression technologies) related to digital image data, variety of functions contained in MFPs have been increased.

Furthermore, variety of purposes, for which MFPs are used, has also been increased. For instance, MFPs can be classified into: compact type that is typically placed side by side with a personal computer (PC) so that an operator can use copier, facsimile, printer, and scanner functions of the MFP conveniently; medium-sized type that is typically shared by a plurality of users in a section or a department and has a certain level of productivity and advanced functions, such as sorting and stapling; and large-sized versatile type that is of high-productivity and high-image quality, and typically used in a section involved in copy-related operations of entire company in a centralized fashion or a company that conducts business of copy-related operations.

Of MFPs that have thus been increased in variety ranging from small-size classes to large-size classes, some functions are common to all the size classes, but some functions are specifically required by certain size class. For instance, large-sized MFPs are required to be capable of performing finishing operations, such as punching, stapling, and folding, on printed paper, filing image data as electronic file while the MFP is printing the image data, and the like, whereas small-sized MFPs are required to serve as an internet facsimile, a PC-FAX, and the like and be capable of forming a high-quality image, for personal use, on special paper.

Systems, each configured by combining functions necessary for a target class, have conventionally been introduced to and provided in the market of the MFPs that have thus been increased in variety.

It has already been granted that information is of great value in business. Required is not only to transmit information quickly, accurately, and without fail but also to provide information effectively and in a manner easy to understand. With speedup and proliferation of network communications, increase in capacity and reduction in price of memory, and enhanced processing power of PCs, new technologies for efficiently handling information based on digital data have become available. Under the circumstances, demand that MFPs that handle digital image data, which is one type of digital data, provide new function or be merged with new function has grown.

With increasing demand for high productivity, demand for simultaneous duplex scanners has also grown in recent years. Typical conventional scanners have produced a duplex copy by scanning the front surface of an original in a document feeder (DF) and thereafter turning the original upside down to scan the back surface. However, this conventional duplex scanning method is disadvantageous in being low in productivity because the scanner turns the original upside down and performs second scan. Under the circumstance, machines, or simultaneous duplex scanners, that simultaneously scan the front surface of an original by using a scanner CCD and the back surface by using a contact image sensor (CIS) in a single scan operation and output electronic image data have been introduced.

A coupling function provided in such a simultaneous duplex scanner is also known. The coupling function allows productivity improvement in printing on paper by coupling MFPs of a same model together via a network so that image data obtained by scanning by one of the MFPs can be transmitted to another one of the same-model MFPs via the network and printed on paper by the another MFP.

A request that images obtained by simultaneous duplex scan be continuously printed by utilizing this coupling function can be made. When performing such printing, variations in image quality that can occur due to variation in MFPs that perform scan are desirably reduced. Hence, demand for image processing that causes different scanner CCDs to output images of a uniform image quality and different CISs to output images of a uniform image quality has grown.

Method and apparatus for image-processing for driving a plurality of types of image sensors of different characteristics by using a same signal processing circuit are disclosed in Japanese Patent Application Laid-open No. 2001-358998. A technique for performing color correction to thereby reduce variations in image signals caused by individual machine differences that result from variations in spectral sensitivity characteristics of scanner CCDs, variations in spectral sensitivity characteristics of infrared-spectrum-blocking filters, and deterioration of scanner optical systems with time is disclosed in Japanese Patent Application Laid-open No. 2006-238408.

Although techniques for causing scanner CCDs to output images of a uniform image quality are described in Japanese Patent Application Laid-open No. 2001-358998 and Japanese Patent Application Laid-open No. 2006-238408, technique for causing a plurality of scanning devices for use in simultaneous duplex scanners to output image of a uniform image quality is not referred to therein. The same correction operation for use by a scanner CCD can be applied to another scanning device, such as a CIS; however, because, even though the correction operation is optimum for the scanner CCD, the correction operation is not optimum for the CIS, applying the correction operation to the CIS results in failure to satisfy criterion for the CIS. To this end, it is desirable to apply different criteria to scanning devices on a scanning-device-by-scanning-device basis so that the scanning devices output images of a uniform image quality by performing different image-processing operations or to change image-processing parameters on a scanning-device-by-scanning-device basis.

Meanwhile, image qualities of images obtained with scanner CCDs are made uniform by performing color correction operation, which is one type of image processing. Because color correction operation is performed for various purposes that include not only to cause scanning devices to output images of a uniform image quality when the coupling function is used but also to perform color conversion (from red, green, blue (RGB) to cyan, magenta, yellow, black (CMYK)), designated-color removal (including dropout color), and designated-color conversion, the number of image-processing parameters and amounts of computations related to color correction are at their maximum. Accordingly, time required to control color correction operation is disadvantageously longer than time required to perform other image-processing operations. Therefore, it is essential to reduce time required to perform color correction operation for productivity improvement.

FIG. 18 is a diagram schematically depicting operations performed by a conventional image-processing control device. This image-processing control device 103 has, as its functions, image-processing-parameter calculation 101 and image-processing-parameter setting 102 and performs the image-processing-parameter calculation 101 and image-processing-parameter setting 102 according to settings 201 entered via an operating unit (hereinafter, “operating-unit settings 201”). Speedup of these operations leads to high productivity.

FIG. 19 is a diagram schematically depicting operations performed by another conventional image-processing control device. This image-processing control device 103 includes an image-processing-parameter calculating unit 203 and an image-processing-parameter setting unit 205 that are independent of each other. The image-processing-parameter setting unit 205 performs image-processing-parameter difference management 204. Because there are a large number of setting items (selected application, color mode, image-quality mode, image density, contrast, and the like) to be specified via an user interface (UI), settings to be entered via service mode, and other settings (about update of a reference-chart read value), the image-processing-parameter calculating unit 203 performs the image-processing-parameter calculation 101 each time without performing a difference management 202. The image-processing-parameter setting unit 205 performs difference management of a calculation result output from the image-processing-parameter calculating unit 203, and establishes image-processing parameters of a control-target device only when it is determined that there is a difference between current and previous calculation results.

However, each of the image-processing control devices depicted in FIGS. 18 and 19 is disadvantageous in that, because the image-processing control device performs the image-processing-parameter calculation 101 each time irrespective of whether settings established via the operating unit have been changed, the image-processing-parameter calculating unit 203 is required to perform a large amount of computations, which prevents productivity improvement.

### SUMMARY OF THE INVENTION

It is an object of the present invention to at least partially solve the problems in the conventional technology.

According to an aspect of the present invention, there is provided an image forming apparatus that includes: an operating unit; a plurality of scanner units each obtaining image data by scanning; an image processing unit capable of adjusting reading characteristics by correcting the image data fed from the scanner units; an image-processing control unit, the image-processing control unit including: an image-processing-parameter calculating unit that calculates an image-processing parameter according to settings entered via the operating unit to output a calculation result; an image-processing-parameter storing unit that stores the calculation result; and an image-processing-parameter setting unit that sets the image-processing parameter stored in the image-processing-parameter storing unit as an image-processing parameter of the image processing unit; and a difference-in-setting determining unit that makes a determination as to whether there is difference between previous settings and current settings established via the operating unit. The image-processing-parameter calculating unit includes a first calculating unit that calculates the image-processing parameter when the difference-in-setting determining unit has determined that there is the difference.

According to another aspect of the present invention, there is provided a method for setting an image-processing parameter of an image processing unit in an image forming apparatus that includes an operating unit, a plurality of scanner units each obtaining image data by scanning, and the image processing unit capable of adjusting reading characteristics by correcting the image data fed from the scanner units. The method includes calculating an image-processing parameter according to settings established via the operating unit to output a calculation result; setting the calculation result as an image-processing parameter of the image processing unit; making determination as to whether there is difference between previous settings and current settings established via the operating unit. The calculating is performed when the making determination has determined that there is the difference.

According to still another aspect of the present invention, there is provided a computer program product that causes a computer to execute the method according to the present invention.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of an image forming apparatus according to a first embodiment of the present invention;

FIG. 2 is a schematic diagram illustrating flows of image data in the image forming apparatus illustrated in FIG. 1;

FIG. 3 is a table presenting correspondences between applications and image data paths in the image forming apparatus illustrated in FIG. 1;

FIG. 4 is a schematic diagram illustrating relations among a controller, an upper-level control device, and an image-processing control device in the image forming apparatus illustrated in FIG. 1;

FIG. 5 is a call timing diagram for scanning and plotting related to the upper-level control device illustrated in FIG. 5;

FIGS. 6A and 6B are diagrams illustrating image processing performed inside hardware and middleware included on an image processing unit (IPU) illustrated in FIG. 1;

FIG. 7 is a diagram schematically illustrating operations performed by the image-processing control device illustrated in FIG. 4;

FIGS. 8A and 8B are tables of examples of settings to be entered via a control panel illustrated in FIG. 7;

FIG. 9 is a diagram illustrating an example reference chart;

FIGS. 10A and 10B are tables of examples of items assumed by the image-processing control device as controlling factors for a color-correction processing unit illustrated in FIGS. 6A and 6B;

FIGS. 11A and 11B are flowcharts of an example control flow of operations performed in the image-processing control device in response to a calculation request;

FIG. 12 is a flowchart of an example control flow of operations performed to calculate image-quality parameters for the color-correction processing unit illustrated in FIGS. 6A and 6B;

FIG. 13 is a flowchart of an example control flow of operations performed in the image-processing control device in response to a setting request;

FIGS. 14A and 14B are schematic diagrams illustrating an example image-processing modules in hardware and those in middleware according to a second embodiment of the present invention;

FIG. 15 is a flowchart of an example control flow of operations performed in the image-processing control device in response to a setting request according to the second embodiment;

FIG. 16 is a diagram schematically illustrating operations performed by the image-processing control device according to the second embodiment;

FIG. 17 is a diagram illustrating a method, in which efficiency in only the difference management is increased;

FIG. 18 is a diagram schematically illustrating operations performed by a conventional image-processing control device; and

FIG. 19 is a diagram schematically illustrating operations performed by another conventional image-processing control device.

### DETAILED DESCRIPTION OF THE PREFERRED EMBODIMENTS

Exemplary embodiments of the present invention are described in detail below with reference to the accompanying drawings.

### First Embodiment

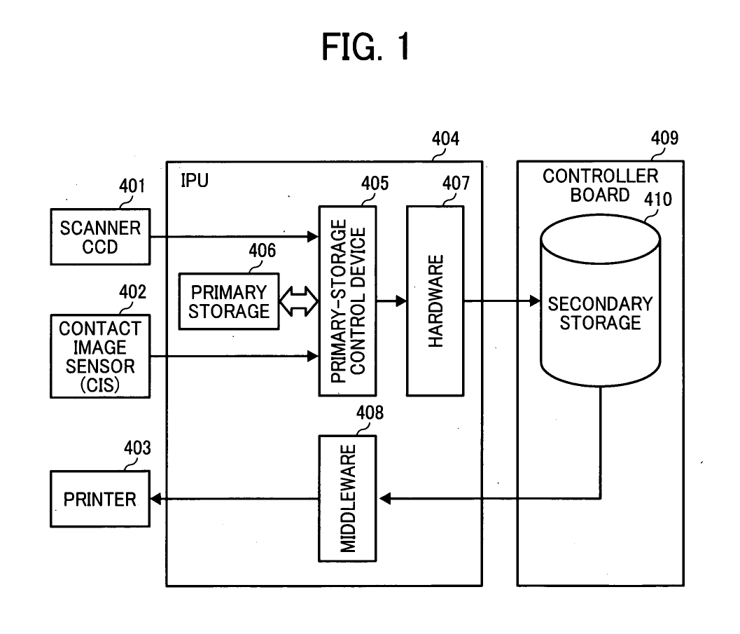

FIG. 1 is a block diagram of an image forming apparatus according to a first embodiment of the present invention. This image forming apparatus is an MFP that includes a scanner charge coupled device (CCD) 401, a contact image sensor (CIS) 402, which form a scanner unit, a printer 403, an image processing unit (IPU) 404, and a controller board 409.

The IPU 404 incorporates an image processing device (image processing unit) that includes a primary storage 406, a primary-storage control device 405, hardware (application-specific integrated circuit (ASIC)) 407, and middleware (digital signal processor (DSP)) 408. The controller board 409 incorporates a secondary storage 410.

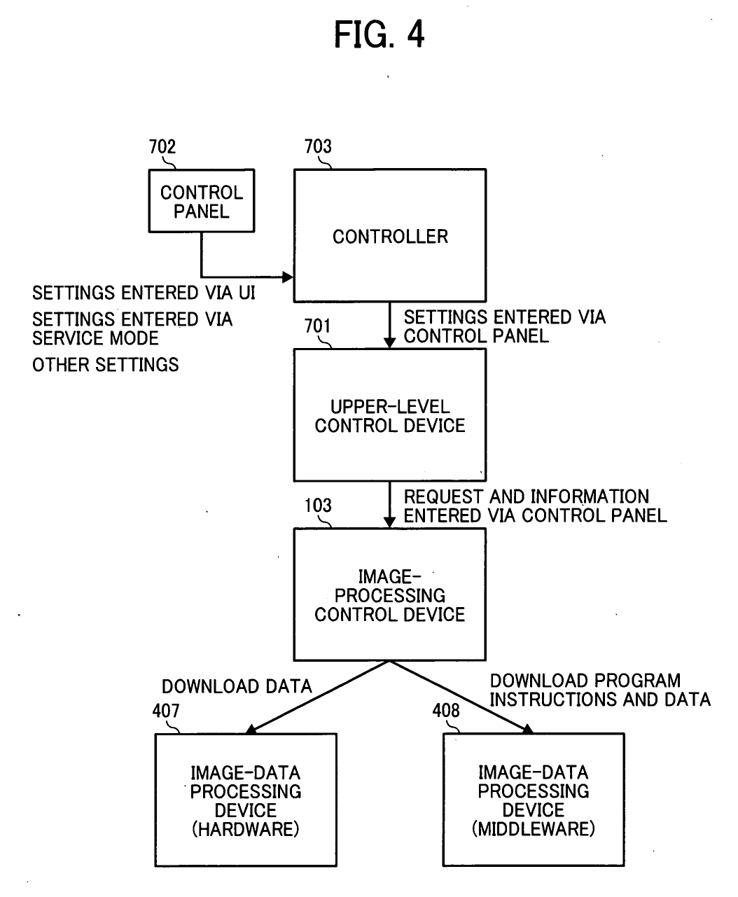

In the first embodiment, the image-processing control device 103 (FIG. 4), which will be described later, controls only the hardware 407 and middleware 408. Particularly during simultaneous duplex scanning, timing control for data input and data output, such as alternately storing image data pertaining to a front surface of an original and image data pertaining to a back surface in the primary-storage control device 405 and the primary storage 406, to and from the image-processing control device is not performed the image-processing control device 103 but performed by other built-in image-processing control device in the image forming apparatus. Put another way, the image processing control device 103 has a function of sending image data to the hardware 407 and the middleware 408 and, before image processing is started, establishes such image-processing parameters that allow optimum image processing in the image processing device.

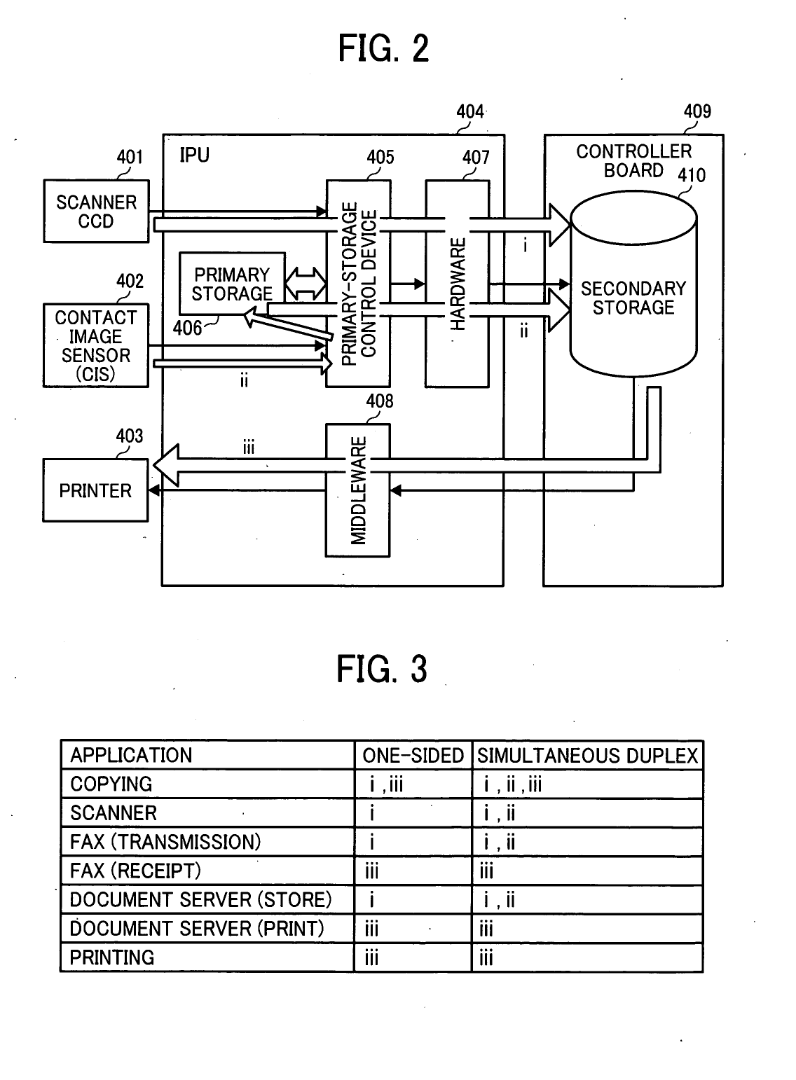

FIG. 2 is a schematic diagram illustrating flows of image data in the image forming apparatus illustrated in FIG. 1. The image forming apparatus contains seven types of application software (hereinafter, “application”), or specifically copying, scanner, FAX (receipt/transmission), document server (store/print), and printing. The image forming apparatus also has a coupling function that allows, while the image forming apparatus is operating as a host apparatus, scanned image to be sent to the printer 403 of its own and to the printer 403 of a client apparatus (not shown) connected with the image forming apparatus via a local area network (LAN) (not shown) to be printed by the client apparatus. Flows of image data are illustrated in FIG. 2.

Flow paths of image data have wide variety because scanning can be performed by either one-sided scanning that uses only the scanner CCD 401 or simultaneous duplex scanning that uses both the scanner CCD 401 and the CIS 402; however, the various data flow paths can be implemented by combining three data paths, which are denoted by “i,” “ii,” and “iii,” as illustrated in FIG. 2.

FIG. 3 is a table presenting correspondences between applications and image data paths. For one-sided printing by using “COPIER” in FIG. 3, data flows as follows: Image data is fed from the scanner CCD 401 via the primary-storage control device 405 to the hardware 407 where the image data undergoes a correction operation to be performed on an image fed from the scanner. The image data is then transmitted to the secondary storage 410 in the controller board 409. Thereafter, the image data is returned from the controller board 409 to the IPU 404, in which the image data is fed to the middleware 408 where the image data undergoes a correction operation that is to be performed on an image to be fed to the printer 403. The image data is then transmitted to the printer 403 and printed by the printer 403 on paper.

In a case of simultaneous duplex scanning, the image data path “ii” for a back surface is added to image-processing path for the one-sided printing with the COPYING described above. Because this image-processing path includes only a single piece of the hardware 407, an image fed from the scanner CCD 401 and an image fed from the CIS 402 cannot be processed simultaneously. Accordingly, the primary-storage control device 405 causes the image fed from the CIS 402 to be temporarily stored in the primary storage 406 until completion of image processing performed by the hardware 407 on the image fed from the scanner CCD 401. After completion of the image processing performed on the image fed from the scanner CCD 401, the image fed from the CIS 402 is returned via the primary-storage control device 405 to the hardware 407 where the image undergoes correction operation, and thereafter the image data is transmitted to the secondary storage 410 in the controller board 409.

An image-processing path from the secondary storage 410 in the controller board 409 to the printer 403 is as follows: The image data fed from the scanner CCD 401 is transmitted to the middleware 408 first so as to undergo the correction operation to be performed on an image to be fed to the printer 403, and then transmitted to the printer 403. Thereafter, similar operations are performed on the image data fed from the CIS 402 to output a double-sided printout.

Image-processing paths for “SCANNER,” “FAX (TRANSMISSION),” and “DOCUMENT SERVER (STORE)” are generally as follows: When one-sided printing is to be performed, image data is transmitted through the image data path “i,” which is the image data path for one-sided printing with the “COPYING” to the hardware 407. When duplex printing is to be performed, image data is transmitted through the image data path “i” and “ii,” which are the image data paths for duplex printing with the “COPYING” to the hardware 407. The image data having undergone image processing in the hardware 407 is transmitted to the secondary storage 410 in the controller board 409. For “DOCUMENT SERVER (PRINT),” the image data is stored in the secondary storage 410. For “SCANNER” and “FAX (TRANSMISSION),” the image data is transmitted to a client PC or the printer 403 connected via a network, such as the LAN.

Each of one-sided printing and duplex printing with the “SCANNER,” “FAX (TRANSMISSION),” and “DOCUMENT SERVER (STORE),” is performed through a same image-processing path as follows: Image data is transmitted from the controller board 409 to the middleware 408 where the image data undergoes the correction operation to be performed on an image to be fed to the printer 403, then the image data is fed to the printer 403 to be printed on paper (the image data path “iii”).

When the coupling function is used, image data paths in a host apparatus are basically as follows: For one-sided printing, image data flows through the image data path “i,” which is the image data path for one-sided printing with the COPYING whereas for duplex printing, image data flows through the image data path “i” and “ii,” which are the image data paths for duplex printing with the COPYING. Image data obtained by scanning by the host apparatus is transmitted from the controller board 409 to a client apparatus connected to the host apparatus via a network such as a LAN. The image data is printed on paper by the printer 403 of the client apparatus.

FIG. 4 illustrates relations among a controller 703, an upper-level control device 701, and the image-processing control device 103. The controller 703 is control software that controls a controller unit in a CPU in the controller board 409. Each of the upper-level control device 701 and the image-processing control device 103 is control software in a CPU (which is incorporated in the IPU 404) provided to control an engine unit that includes the IPU 404, the scanner CCD 401, the CIS 402, and the printer 403.

Settings specified by an user via the user interface (UI) (hereinafter, “UI settings”); settings established via a service mode (hereinafter, “service-mode settings”), and other information, such as a reference-chart read value, are transmitted via the upper-level control device 701 to the image-processing control device 103.

The image-processing control device 103 receives from the upper-level control device 701 the information (settings on original mode, magnification, density, and the like) specified by the user and establishes image-quality parameters, which are program instructions and/or data, for the hardware 407 and the middleware 408, which are control targets of the image-processing control device 103, so that an optimum image for the user is output.

The upper-level control device 701 transmits user information specified via a control panel 702 and controls readout timing for operations to be performed by the image-processing control device 103. Triggered by a request issued from the upper-level control device 701, the image-processing control device 103 establishes image-processing-parameters of the image processing device according to a called request.

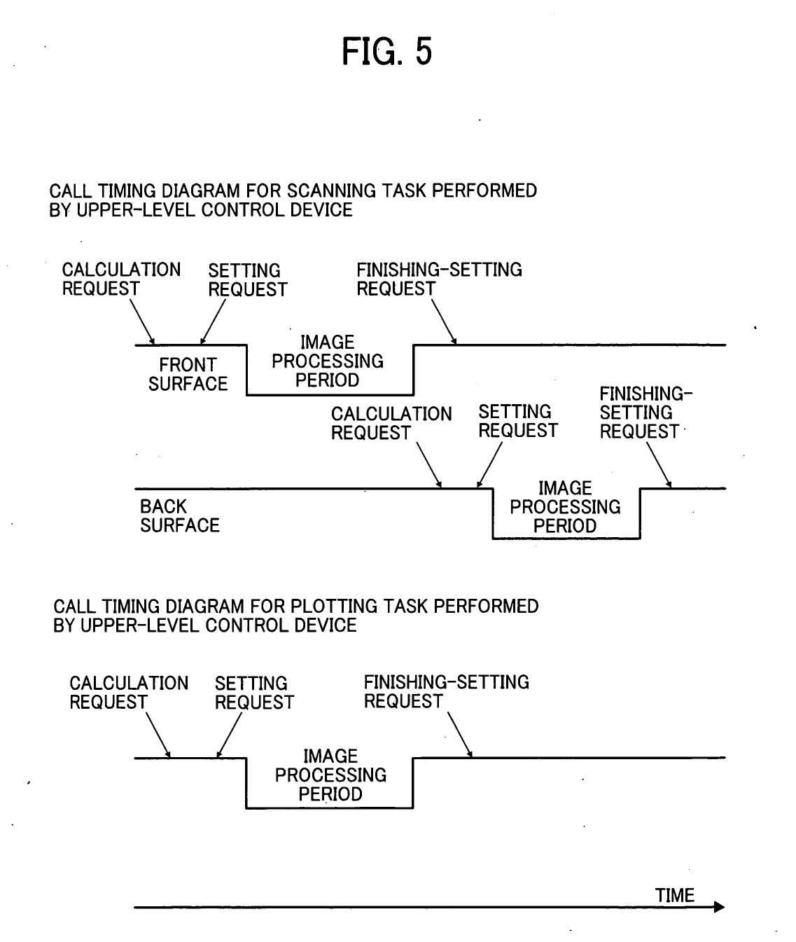

FIG. 5 illustrates an example call timing diagram related to the upper-level control device 701 and the image-processing control device 103. As illustrated in FIG. 5, a series of calls is issued by the upper-level control device 701 for each task. Settings related to image processing for data input by using the scanner or data output by using a plotter are established by the image-processing control device 103. Accordingly, a setting-request sender is any one of two processes, or specifically a scanning process and a plotting process.

In the IPU 404, the scanning process and the plotting process are processed by using the different image processing devices (the hardware 407, the middleware 408). Accordingly, there can be a case where a request for the scanning process and a request for the plotting process overlap in terms of time as illustrated in FIG. 5. The image-processing control device 103 manages image processing on a process-unit basis. Control operations in one process are completed when a calculation request, a setting request, and a finishing-setting request have been processed.

Triggered by the calculation request, the image-processing control device 103 calculates and preserves image-processing parameters to be set as image-processing parameters of the image processing device. Triggered by the setting request, the image-processing control device 103 sets the image processing parameters having been calculated and preserved in advance as the image-processing parameters of the image processing device. Triggered by the finishing-setting request, the image processing control device 103 performs postprocessing to prevent memory leak, such as release of the preserved result of calculation.

The scanning process is performed as follows: When only front surface scan is requested, a calculation request and a setting request are transmitted to the image-processing control device 103 before the image processing device starts image processing, thereby placing the image processing device in a ready-for-image processing state. Then image data is transmitted to the image processing device, causing the image processing device to perform image processing. A finishing-setting request is transmitted so that the image-processing control device 103 completes control operations of a single process. In a case of simultaneous duplex setting request, a request for back surface scan is additionally issued to the image-processing control device 103 in a manner similar to that of the front surface scan, causing the image-processing control device 103 to perform control operations. Plotting process is basically the same as scanning process; however, in the plotting task, the image processing device for which settings are established and the device that performs image processing are different devices.

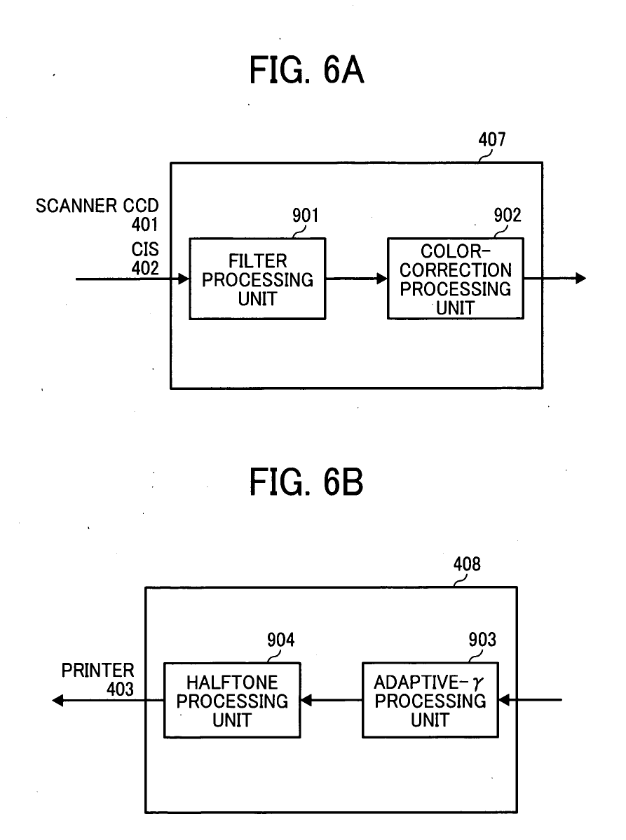

FIGS. 6A and 6B are schematic diagrams illustrating an example image-processing modules in the hardware 407 and those in the middleware 408. FIGS. 6A and 6B illustrate image processing performed inside the hardware 407 and the middleware 408, which are image processing devices included on the IPU 404. FIG. 6A illustrates the hardware 407 and FIG. 6B illustrates the middleware 408.

The hardware 407 implements a filter processing unit 901 and a color-correction processing unit 902 for use in correcting image data fed from the scanner CCD 401 or the CIS 402. The filter processing unit 901 performs, on a target image, edge enhancement and smoothing for noise removal, and processing for causing modulation transfer function (MTF) characteristics of the image data fed from the scanner CCD 401 or the CIS 402 to approach predetermined MTF characteristics. The color-correction processing unit 902 performs operations for causing scanning devices to output images of a uniform image quality when the coupling function is used, color conversion (from RGB to CMYK), designated-color removal (including dropout color), designated-color conversion, and the like.

The middleware 408 includes an adaptive-γ processing unit 903 and a halftone processing unit 904 and performs image processing for the printer 403 that are adapted to printer characteristics. More specifically, because a requested number of halftone levels of input image data differs from that of output image data, the middleware 408 performs conversion to change the number of levels of halftone by using the adaptive-γ processing unit 903 and the halftone processing unit 904.

In the first embodiment, these four modules are target modules of control operations performed by the image-processing control device 103. Because operations for causing the scanning devices to output images of a uniform image quality are performed by the color-correction processing unit 902, descriptions are made with emphasis on control operations performed by the color-correction processing unit 902.

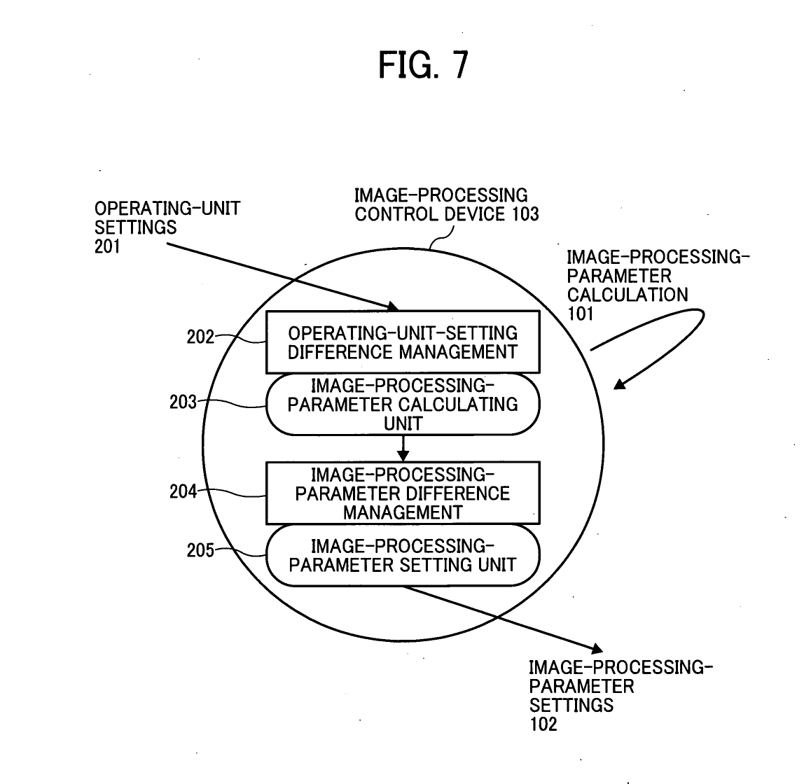

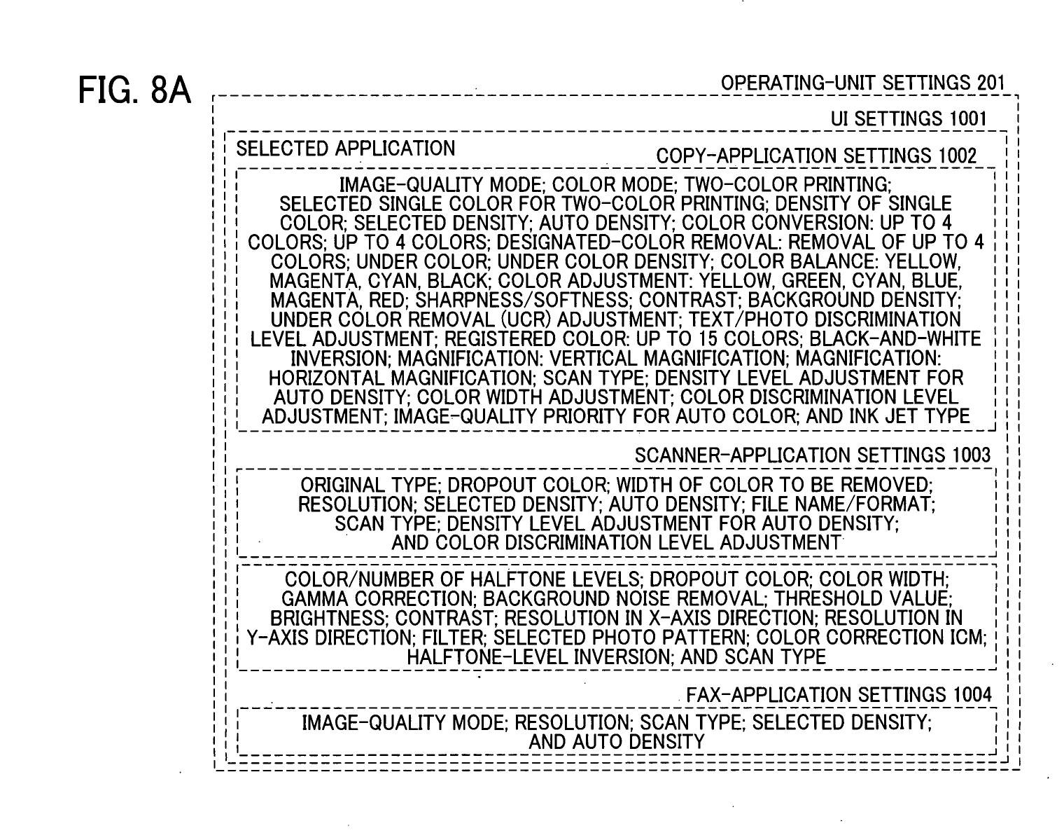

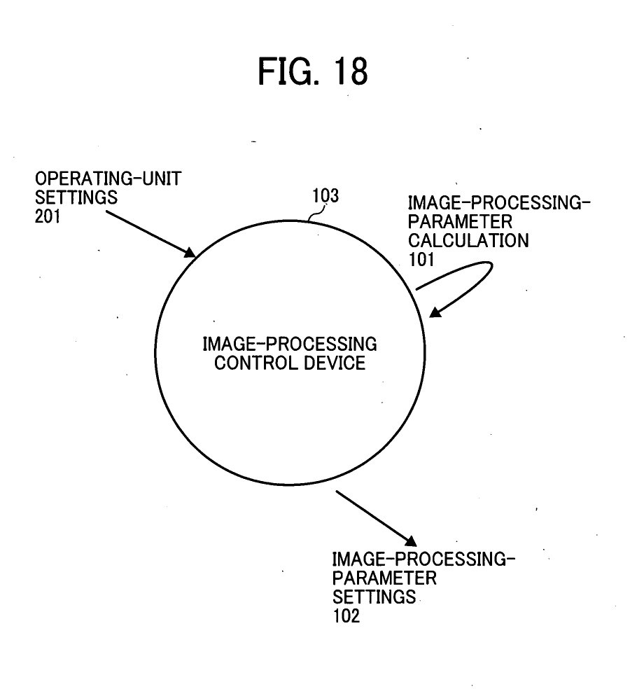

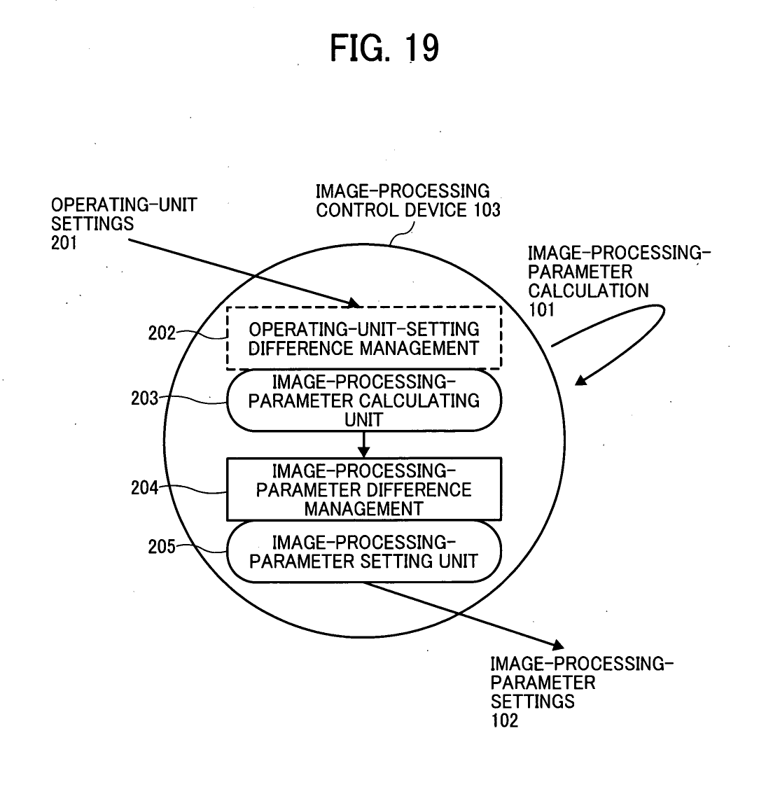

FIG. 7 is a diagram schematically illustrating operations performed by the image-processing control device 103. The image-processing control device 103 includes, as its functional blocks, the image-processing-parameter calculating unit 203 and the image-processing-parameter setting unit 205. According to the operating-unit settings 201, the image-processing-parameter calculating unit 203 performs the image-processing-parameter calculation 101, and the image-processing-parameter setting unit 205 establishes the image-processing-parameter setting 102. The configuration of the image-processing control device 103 thus far described is the same as the configuration of the conventional device illustrated in FIG. 18.

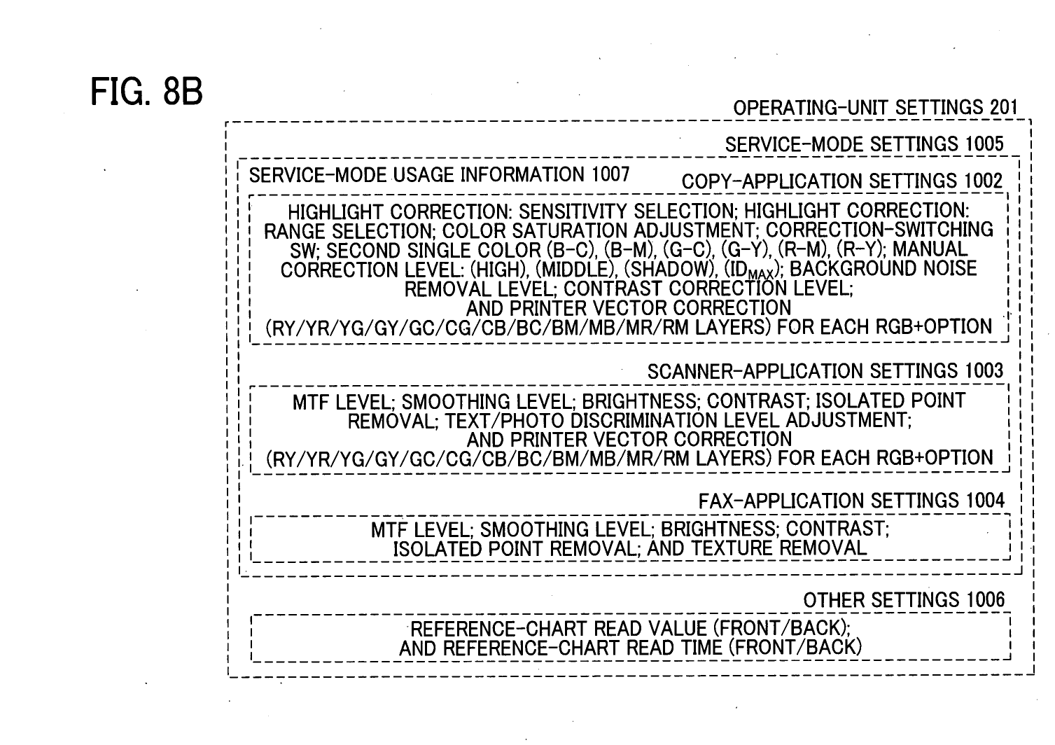

However, in contrast to the conventional apparatus, the difference management 202 of the operating-unit settings 201 is performed in the first embodiment. As for UI settings that can be specified by a general user, the difference management of only control factors for color correction processing that involves the image-processing-parameter calculation 101, which is time-consuming, is performed. As for service-mode settings that can be specified only by super users having knowledge of service-person commands, the difference management is performed based on usage status of the service mode. As for other settings, the difference management is performed based on time at which a read value is updated. Each of the settings will be described with reference to FIGS. 8A and 8B.

In the first embodiment, scanning of the reference chart for use in causing the scanner units to output images of a uniform image quality is performed. By performing the difference management 202 by using, as information for difference comparison, information about reference-chart read time and information about usage of the service mode (hereinafter, “SP mode”) for the MFP capable of simultaneous duplex scanning, determination as to whether a result of image-quality-parameter calculation and image-quality-parameter settings have changed from previous settings can be made efficiently. If the settings are the same as the previous settings, speedup can be achieved by not performing the image-processing-parameter calculation 101 and the image-processing-parameter setting 102.

FIGS. 8A and 8B illustrate examples of the operating-unit settings 201. Information presented in FIGS. 8A and 8B is limited to information that is to be fed to the image-processing control device 103 and that affects image quality. The operating-unit settings 201 are classified into UI settings 1001 that can be specified by general users, service-mode settings 1005 that can be specified only by super users having knowledge of service-person commands, and other settings 1006.

The UI settings 1001 vary on an application-by-application basis. The service-mode settings 1005 include menu items that are common to all applications. The image-processing control device 103 switches, for each application, from some items to other items of the menu items so that corresponding items are referred to by the application. The UI settings 1001 include copy-application settings 1002, scanner-application settings 1003 (distribution/TWAIN), and FAX-application settings 1004. Because these settings are entered via different UIs, menu items for these settings differ from one another. A user is allowed to specify settings on menu items indicated in a dotted box provided for each application.

The service-mode settings 1005 provides a function of defining, for each application, menu items settings of which can be established from the application on a single screen. This function is implemented by causing the image-processing control device 103 to switch from some items to other items of the menu items so that corresponding items are referred to by a selected application. Service-mode usage information 1007 is ON/OFF information indicative of whether the service-mode screen has been activated. The service-mode usage information 1007 is in ON state when the MFP is placed in the service mode but returns to OFF upon completion of operation of any one of the applications that has been activated after the MFP has gone out from the service mode.

With regard to the other settings 1006, when scan of the reference chart is performed from the service mode to an execution-type mode, resultant read value obtained by scanning the reference chart is stored. Although a user is not allowed to overwrite the read value, the reference-chart read value is updated every time the reference-chart scanning is performed. Read values are stored in memory areas that are provided on a scanner-unit-by-scanner-unit basis. Read time indicative of when the reference chart has been scanned is also stored.

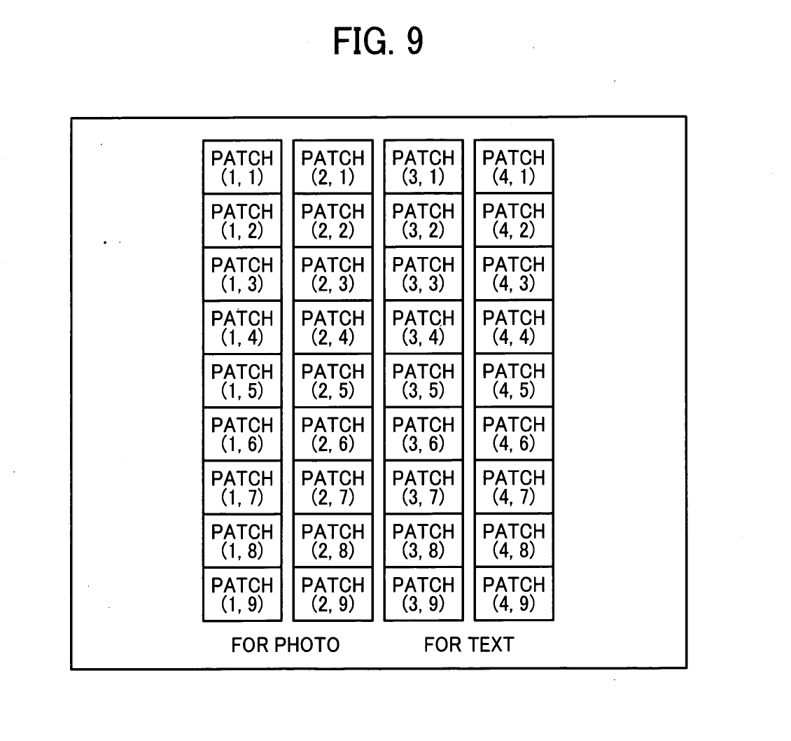

FIG. 9 is a diagram illustrating an example reference chart. Because FIG. 9 represents only an example of the reference chart, detailed descriptions about arrangement and the number of patches are omitted. By scanning this example chart, 108 values, which are read values for each of RGB components for each of a plurality of patches, are stored for each scanner unit.

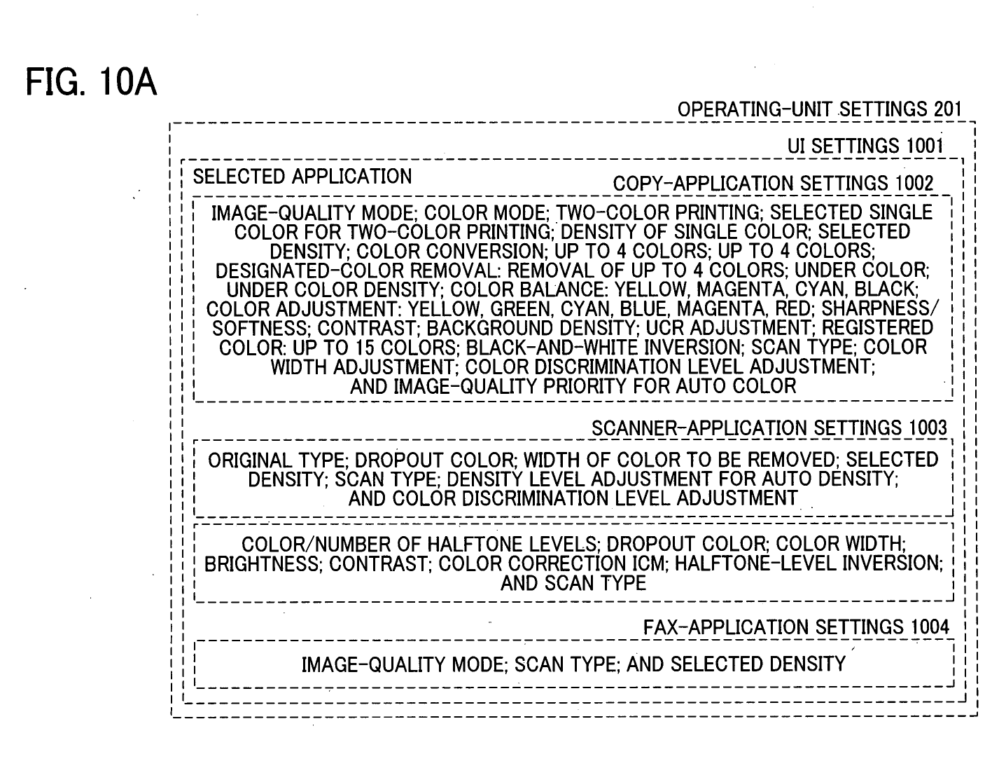

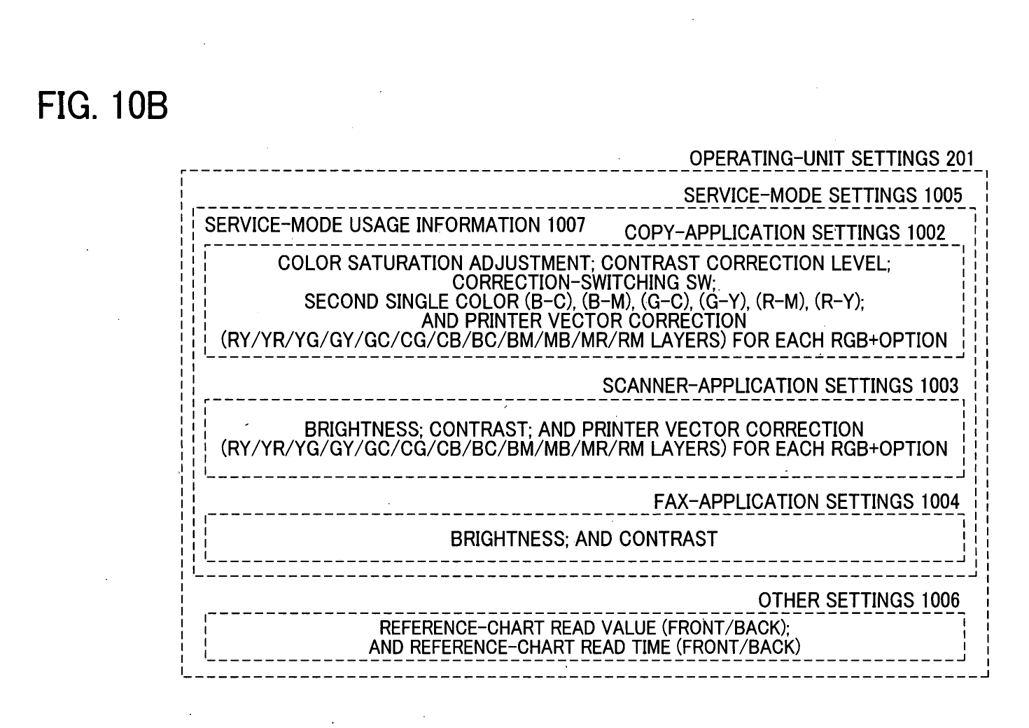

FIGS. 10A and 10B are tables of examples of items assumed by the image-processing control device 103 as controlling factors for the color-correction processing unit 902. As described above, because the color-correction processing unit 902 is used for various purposes, the controlling factors are large in number. Information for use in difference management in the operating-unit-setting difference management 202 performed by the image-processing control device 103 includes the UI settings 1001 of a selected application (the copy-application settings 1002, the scanner-application settings 1003, or the FAX-application settings 1004), the service-mode usage information 1007, and reference-chart read time (front/back) that belongs to the other settings 1006 illustrated in FIGS. 10A and 10B.

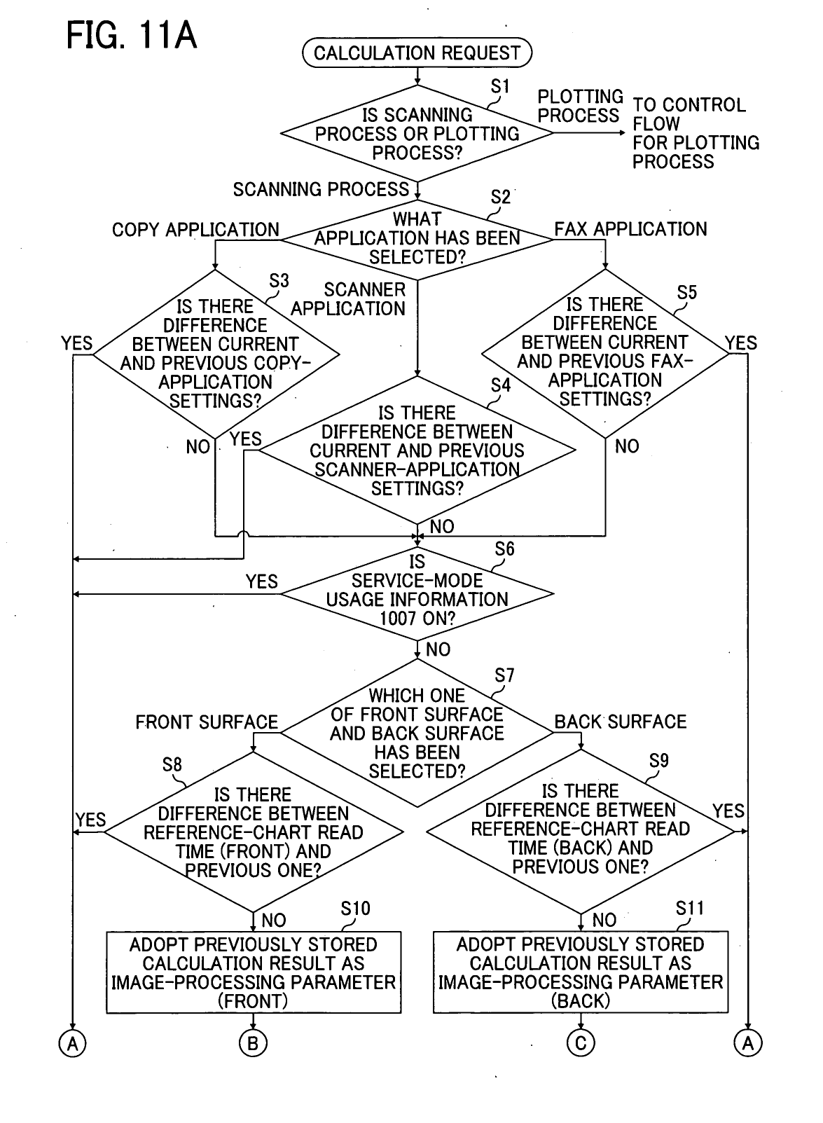

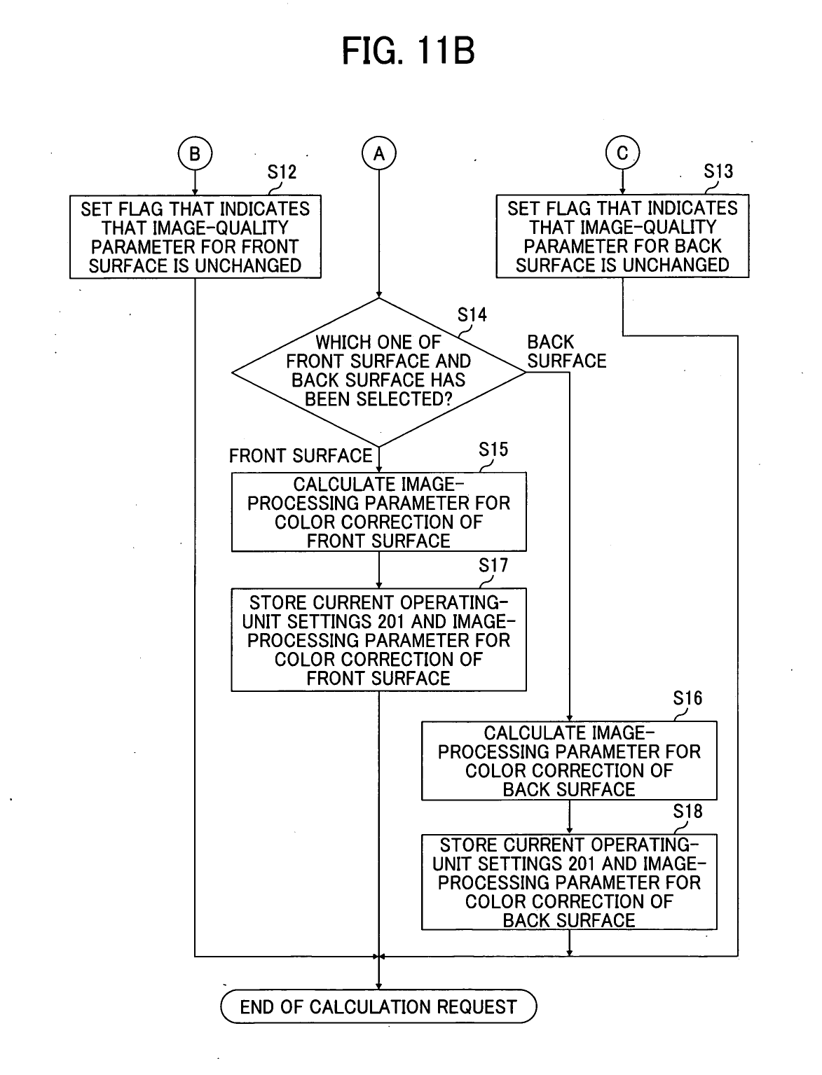

FIGS. 11A and 11B are flowcharts of an example control flow of operations performed in the image-processing control device 103 in response to a calculation request. This control flow illustrates flow of operations performed by the image-processing control device 103 upon receiving the calculation request illustrated in FIG. 5 from the upper-level control device 701 illustrated in FIG. 4. Because descriptions are made with emphasis on the difference management for the color-correction processing unit 902 and the image-processing-parameter calculating unit 203, descriptions and control flow about other operations are omitted.

First, which one of the scanning process and the plotting process is involved in the calculation request is determined (Step S1). If the scanning process of which image-processing path includes the color-correction processing unit 902 is involved, difference-management operation is performed. Operations for the operating-unit-setting difference management 202 correspond to operations pertaining to Steps S2 and S3 in the control flow. Operations pertaining to Steps S4 to S8 correspond to image-processing-parameter calculation to be performed by the image-processing-parameter calculating unit 203.

To perform the difference management, what application has been selected is determined first (Step S2). More specifically, which one of the copy-application settings 1002, the scanner-application settings 1003, and the FAX-application settings 1004 among the UI settings 1001 has been selected is determined to determine a target of difference comparison. Subsequently, settings on the target application are compared with its previous settings to determine whether there is a difference (Steps S3 to S5). Because comparison target items, for which comparison is to be performed, are presented in FIGS. 10A and 10B, detailed descriptions thereabout are omitted. For instance, in the case of the scanner application for distribution scan, difference comparison is performed about seven items, a first one of which is “Original Type” while in the case of the scanner application for TWAIN scan, difference comparison is performed about eight items, a first one of which is “Color/Number of Halftone Levels.”

If it is determined that there is no difference (NO at Step S3, S4, or S5), determination as to the service-mode usage information 1007 is made (Step S6). If the service-mode usage information 1007 is ON at this step, it is indicated that the MFP has entered into the service mode after previous use of the MFP. In this case, it is determined that a difference has been produced between current settings on items that can be specified in the service-mode settings 1005 and previous settings; in contrast, if the service-mode usage information 1007 is OFF, it is determined that no difference has been produced.

If the service-mode usage information 1007 is determined to be OFF, then which one of a front surface and a back surface is to be scanned is determined (Step S7). Thereafter, as a last step of the difference management, determination as to the reference-chart read time (front) (Step S8) or the reference-chart read time (back) (Step S9) is made. Meanwhile, factory-default read values that are obtained on a scanner-unit-by-scanner-unit basis by scanning the reference chart illustrated in FIG. 9 are stored in the secondary storage 410. The reference-chart read time (front) and the reference-chart read time (back) preserved by the image-processing control device 103 are initialized to zero at power-on or at return from an energy conserving mode. If there is found a difference in difference management that is performed when a first calculation request that involves the color-correction processing unit 902 is issued, after image-processing parameters for the color-correction processing unit 902 have been calculated, storing the current operating-unit settings 201 and the image-processing parameters for color correction of the front surface and that of back surface (Step S17, S18) is performed by storing the reference-chart read time (year/month/day/hour/minute/second) information obtained by actually scanning the reference chart in the factory.

In a case where there is a difference between the current operating-unit settings 201 and the previous ones, a case where the service-mode usage information 1007 is ON, or a case where there is a difference between the current reference-chart read time (front/back) and the previous one, recalculation is performed rather than using the previous result of the image-processing-parameter calculation performed for the color-correction processing unit 902 as a current result. First, which one of the front surface and the back surface is to be scanned is determined (Step S14). Image-processing parameters for color correction for the scanner unit corresponding to the thus-determined one of front surface and the back surface are calculated (Step S15, S16). Image-processing-parameter calculation for the color-correction processing unit 902 is then performed.

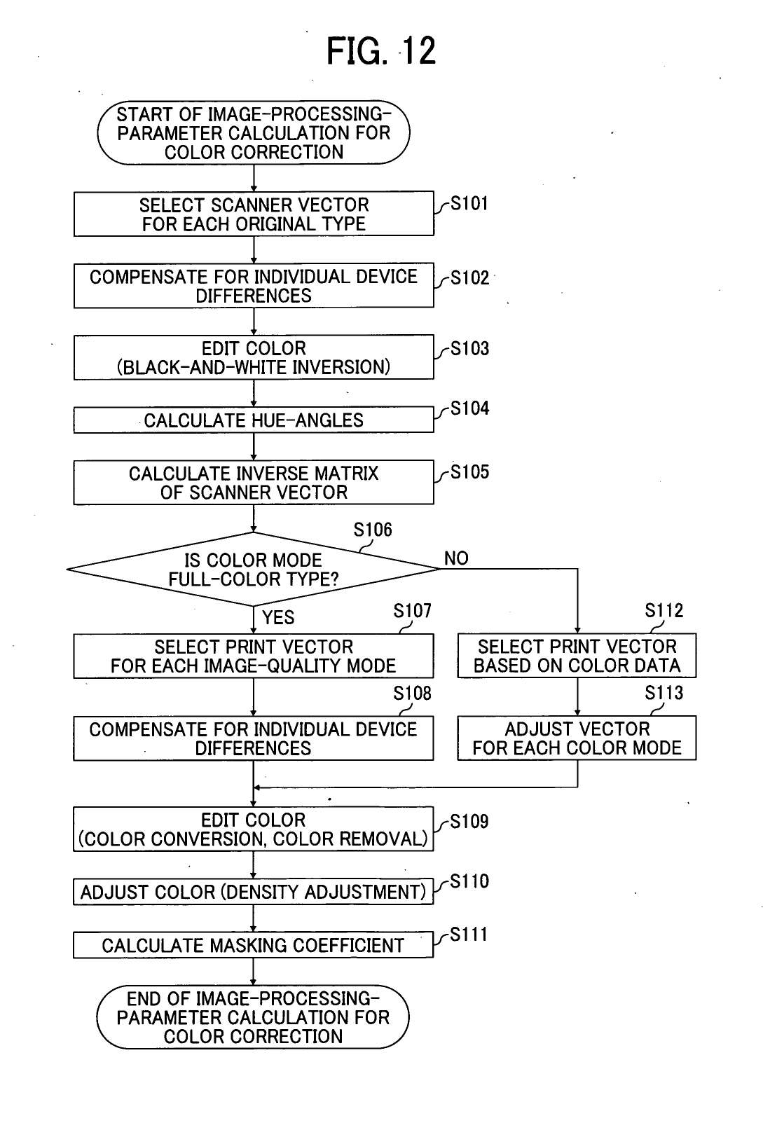

FIG. 12 is a flowchart of an example control flow of operations performed to calculate image-processing parameters for the color-correction processing unit 902. This control flow corresponds to operations pertaining to Steps S15 and S16 in FIG. 11B. Here, it explains only a feature part of the operations and detailed descriptions about the operations are omitted. Among operations in the control flow, operations that affect the result of image-processing-parameter calculation depending on the reference-chart read value are compensating operations for individual device differences (Step S102, S108).

After the current image-processing parameters have been calculated at Steps S15 or S16, if the front surface has been selected, storing the current operating-unit settings 201 and the image-processing parameters for color correction of the front surface or those of back surface (Step S17, S18) is performed by storing the current operating-unit settings 201, the reference-chart read time (front/back), and the result of the image-processing-parameter calculation in memory area provided for each of the front surface and the back surface. When all the operations have been completed, a notification of normal end is sent to the upper-level control device 701 to complete operations performed by the image-processing control device 103 upon receiving the calculation request.

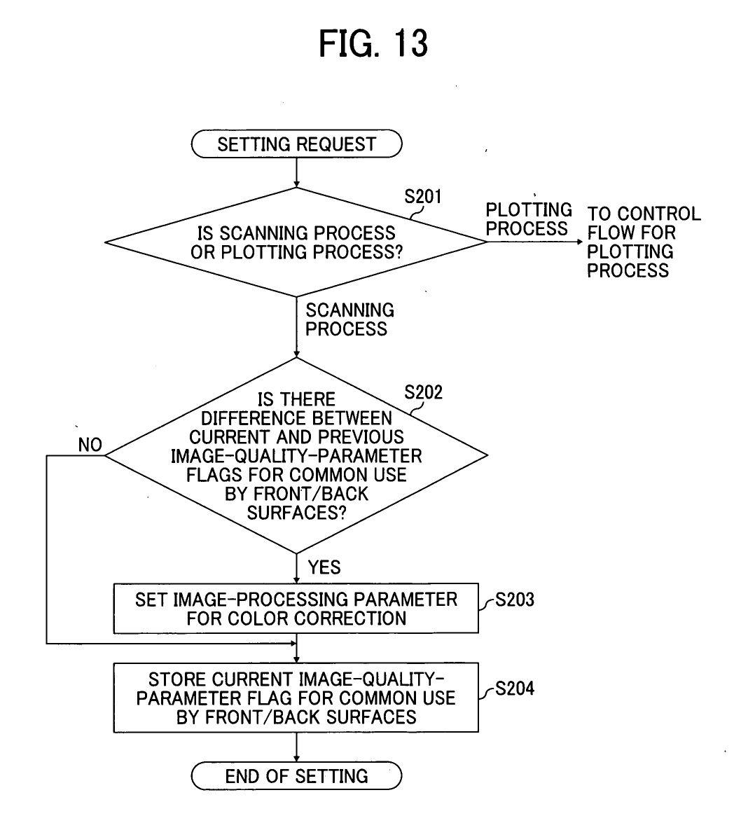

FIG. 13 is a flowchart of an example control flow of operations performed in the image-processing control device 103 in response to a setting request. This control flow illustrates flow of operations performed by the image-processing control device 103 upon receiving the setting request illustrated in FIG. 5 from the upper-level control device 701 illustrated in FIG. 4. As in FIGS. 11A and 11B, because descriptions are made with emphasis on the difference management for the color-correction processing unit 902 and the image-processing-parameter calculating unit 203, descriptions and control flow about other operations are omitted.

As illustrated in FIG. 13, operations pertaining to Steps S201 to Step S204 are performed in order. In the first embodiment, because the color-correction processing unit 902 of the hardware 407, which is the control target of the image-processing control device 103, performs color correction of the front surface and that of the back surface without distinguishing therebetween. Hence, when simultaneous duplex scan is to be performed, whether there is a difference is determined based on an image-quality-parameter flag (image-processing-parameter flag) for common use between the front/back surfaces. Accordingly, although there is produced a difference when switching from the front surface to the back surface or vice versa has occurred, the image-processing-parameter calculation for the color-correction processing unit 902 is not performed but only image-processing-parameter setting for color conversion (Step S203) is performed.

After Step S203, storing current image-quality-parameter flag for common use between the front/back surfaces (Step S204) is performed by storing a flag that indicates that current image-quality parameters of front/back surfaces are unchanged (Step S12, S13). Although a difference related to front/back surfaces is not produced because the image-quality-parameter flag is for common use between the front/back surfaces, image-processing-parameter setting is performed on an assumption that there is the difference because the image-processing-parameter setting is performed by the single, color-correction processing unit 902.

When all the operations have been completed, a notification of normal end is sent to the upper-level control device 701 to complete operations performed by the image-processing control device 103 upon receiving the setting request. Control flow of operations to be performed upon receiving a finishing setting request from the upper-level control device 701 has no specific features related to the difference management, and descriptions about the control flow are omitted.

As described above in detail, the image forming apparatus according to the first embodiment of the present invention has the following advantages (1) to (6).

(1) The image forming apparatus achieves high productivity by comparing current operating-unit settings with previous operating-unit settings to determine whether there is any difference therebetween, and, only when there is the difference, performing the image-processing-parameter calculation 101 and the image-processing-parameter settings 102. The image forming apparatus achieves high productivity particularly when performing continuous copying or scanning of a plurality of sheets in the same settings by performing the image-processing-parameter calculation 101 and the image-processing-parameter settings 102 only for the first sheet of the sheets.

(2) The image forming apparatus includes a difference managing unit for the image-processing-parameter calculating unit 203 and another difference managing unit for the image-processing-parameter setting unit 205 to perform difference management at two stages, thereby simplifying the difference management performed by the image-processing-parameter setting unit 205 and hence achieving high productivity.

(3) Because the menu items for applications differ from one another on an application-by-application basis, by limiting target items of the difference management to be performed by the image-processing-parameter setting unit 205 to items that can be specified from the application, the difference management can be simplified and hence high productivity can be achieved.

(4) The difference management performed by the image-processing-parameter calculating unit 203 is performed based on the difference management of time, at which the reference chart has been scanned, rather than based on read values of reference data, which are values corresponding to patches in a reference chart and stored on a scanner-unit-by-scanner-unit basis. Accordingly, by performing comparison based on information about the read time rather than comparing differences between a plurality of read values for each of the scanner units, determination as to whether there is a difference can be made more simply. By performing the image-processing-parameter calculation 101 and establishing settings for one or more image correcting units (the hardware 407, the middleware 408) only when the thus-simplified difference determining unit has determined that there is the difference, high productivity can be achieved.

(5) The difference management performed by the image-processing-parameter calculating unit 203 is performed based on information about usage of the service mode that can be used only by super users rather than based on individual parameters of the service mode. Accordingly, by performing comparison based on information about time rather than comparing differences between a plurality of read values for each of the scanner units, determination as to whether there is the difference can be made more simply. By performing the image-processing-parameter calculation 101 and establishing settings for one or more image correcting units only when the thus-simplified difference determining unit has determined that there is the difference, high productivity can be achieved.

(6) In the difference management performed by the image-processing-parameter calculating unit 203, a target of the difference management of information about the operating-unit settings 201 is limited only to a factor that affects a result of image-processing-parameter calculation for color correction, which is image processing whose image-processing parameter varies depending on a reference-chart read value. By thus limiting the target of the difference management rather than performing the difference management of all information pieces, in which a difference can be produced, of the operating-unit settings 201, the determination as to whether there is the difference can be simplified. By performing the image-processing-parameter calculation 101 and establishing settings for one or more image correcting units only when the thus-simplified difference determining unit has determined that there is the difference, high productivity can be achieved.

### Second Embodiment

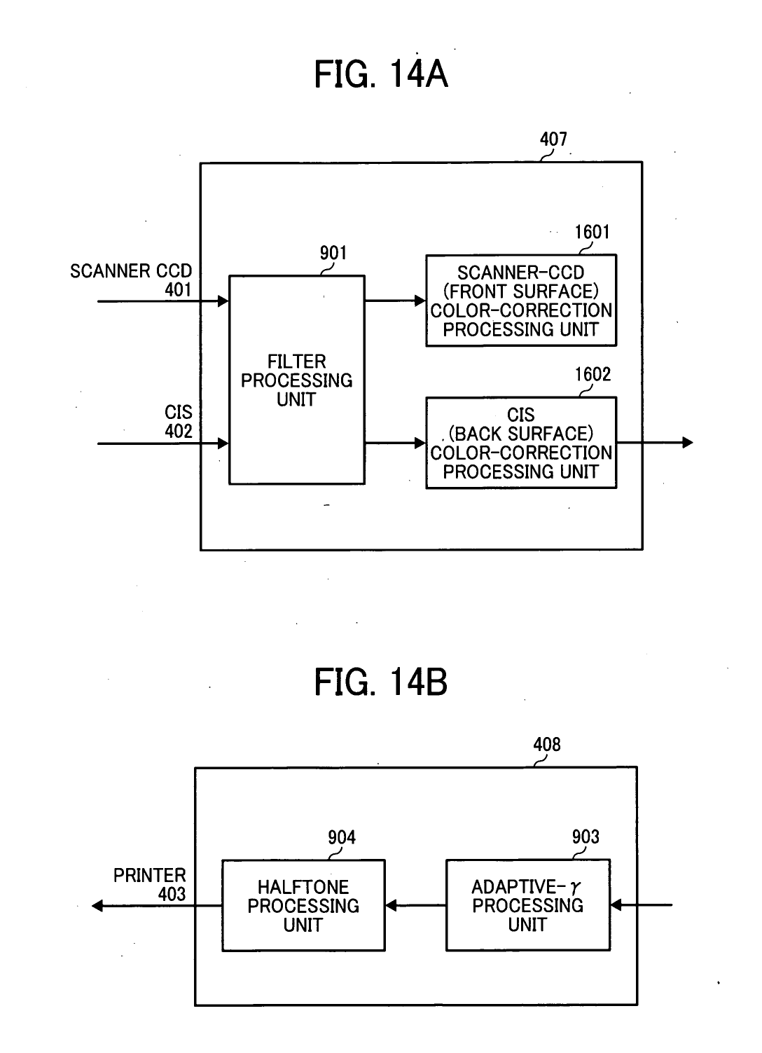

FIGS. 14A and 14B are schematic diagrams illustrating an example image-processing modules in the hardware 407 and those in the middleware 408 according to a second embodiment of the present invention. FIG. 14A illustrates the hardware 407. FIG. 14B illustrates the middleware 408.

The middleware 408 is the same as that of the first embodiment (FIG. 6B). In contrast, the color-correction processing unit in the hardware 407 is divided into a scanner-CCD (front surface) color-correction processing unit 1601 and a CIS (back surface) color-correction processing unit 1602. This configuration allows, when the hardware 407 receives image data transmitted from the upper-level control device 701, to switch from one image-processing path to another to thereby perform image processing on image data read by one of the scanner units independently of image processing on other image data read by other one of the scanner units.

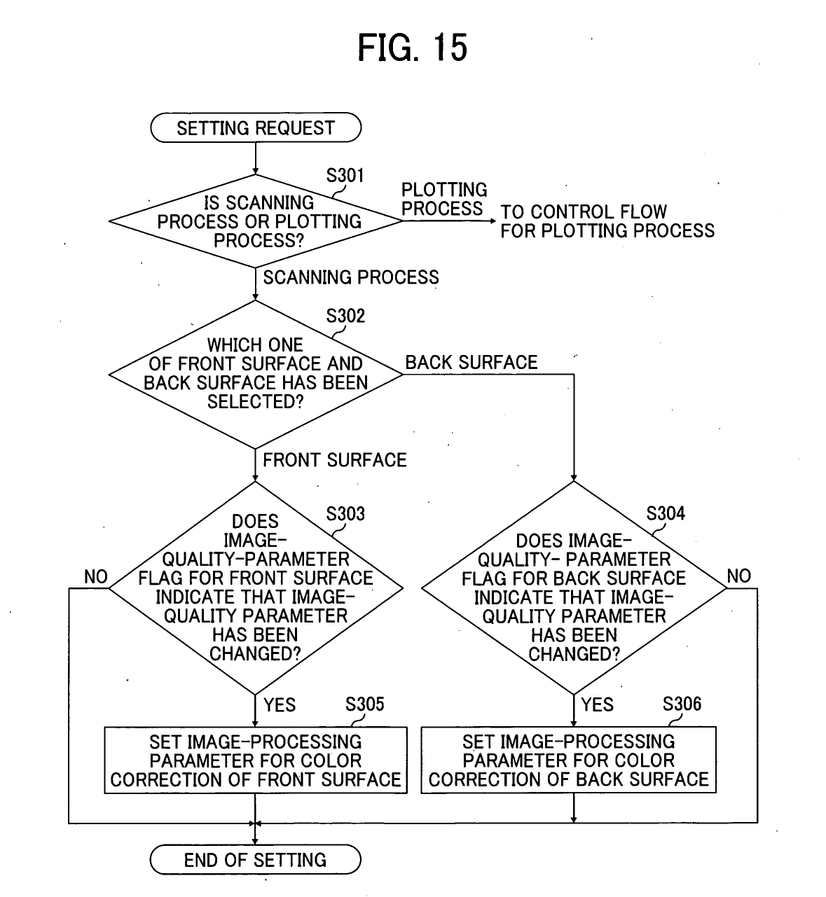

Operations to be performed in the image-processing control device 103 upon receiving a calculation request are performed through a similar control flow to that of the first embodiment (FIGS. 11A and 11B, 12). However, as illustrated in FIG. 15, control flow of operations to be performed upon receiving a setting request differs from that of the first embodiment (FIG. 13).

FIG. 15 is a flowchart of an example control flow of the operations performed in the image-processing control device 103 in response to the setting request according to the second embodiment. Because relations with the upper-level control device 701 and readout timing are the same as those of the first embodiment, descriptions are omitted.

First, which one of the scanning process and the plotting process is involved in the setting request is determined (Step S301). If the setting request involves the scanning process, which one of the front surface and the back surface has been selected is determined (Step S302). If the front surface has been selected, whether the image-quality-parameter flag for the front surface indicates that the image-quality parameter flag are changed is determined (Step S303). Only when it is determined that the image-processing parameter for the front surface is changed (YES at Step S303), image-processing-parameter setting for color correction of the front surface (Step S305) is performed to establish image-processing parameters for the scanner-CCD (front surface) color-correction processing unit 1601. If the back surface has been selected, whether the image-quality-parameter flag for the back surface indicates that the image-quality parameter flag is changed is determined (Step S304). Only when it is determined that the image-processing parameter flag for the back surface is changed, image-processing-parameter setting for color correction of the back surface (Step S306) is performed to establish image-processing parameters for the CIS (front surface) color-correction processing unit 1602.

Because the hardware 407 according to the second embodiment includes the image processing unit for the front surface and the image processing unit for the back surface that are independent of each other, the need of causing the image-processing-parameter setting unit 205 to perform difference management is eliminated. As for establishment of image-quality parameters, which are to be performed by the image-processing-parameter setting unit 205 on a scanner-unit-by-scanner-unit basis, the establishment can be done only by determining whether the image-quality-parameter flag indicates that there is the difference and, only when the flag indicates that there is the difference, establishing image-processing parameters for the color-correction processing units (1601, 1602) provided for each of the scanner units. This lightens load placed on the image-processing control device 103, thereby achieving high productivity.

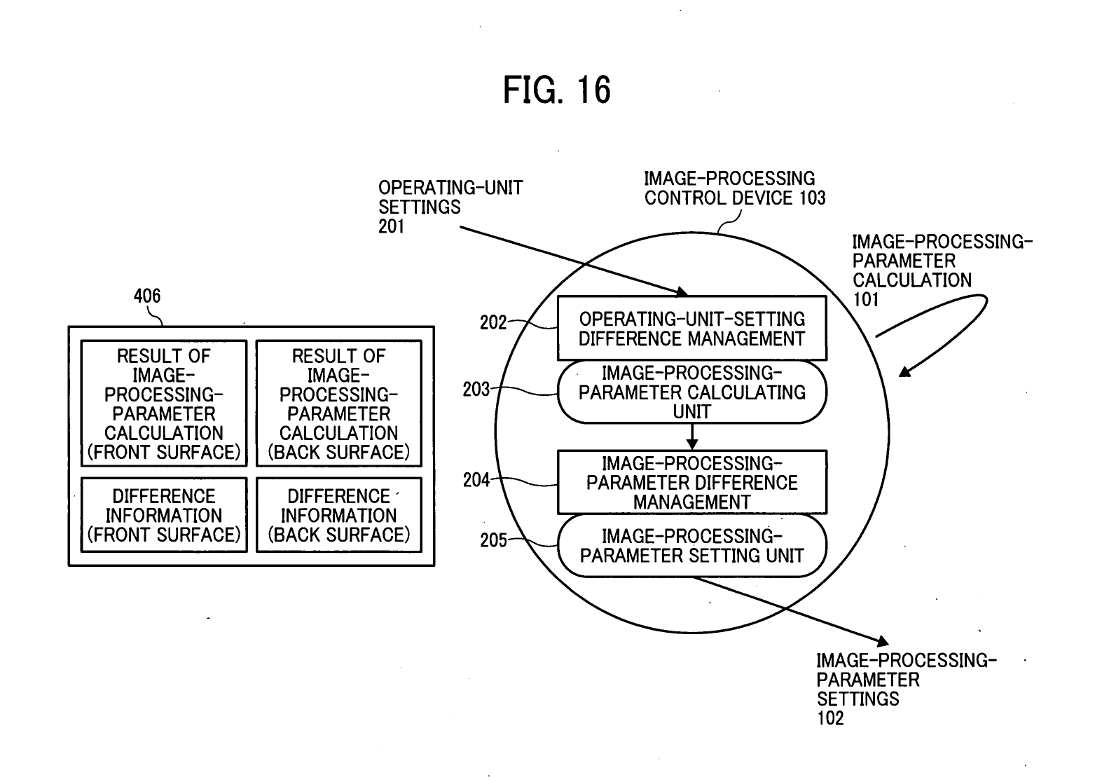

FIG. 16 is a diagram schematically illustrating operations performed by the image-processing control device 103 according to the second embodiment. Storage areas for storing results of image-processing-parameter calculation and difference information for the front surface and those for the back surface are reserved in the primary storage device 406 in advance. If simultaneous duplex scanning is to be performed, comparison and calculation of difference information, which is information indicative of whether to-be-scanned surface has been changed, and the current operating-unit settings 201 are not performed, but a previous result of calculation having been stored is used. Thus, information about the scanner units are managed separately from difference comparison and previous calculation results of image-processing-parameter calculation performed for each of the scanner units are preserved. Accordingly, because there is produced no difference in simultaneous duplex scanning other than the information about the scanner units, the need of the image-quality calculation and image-quality settings can be eliminated, which are advantageous for speedup.

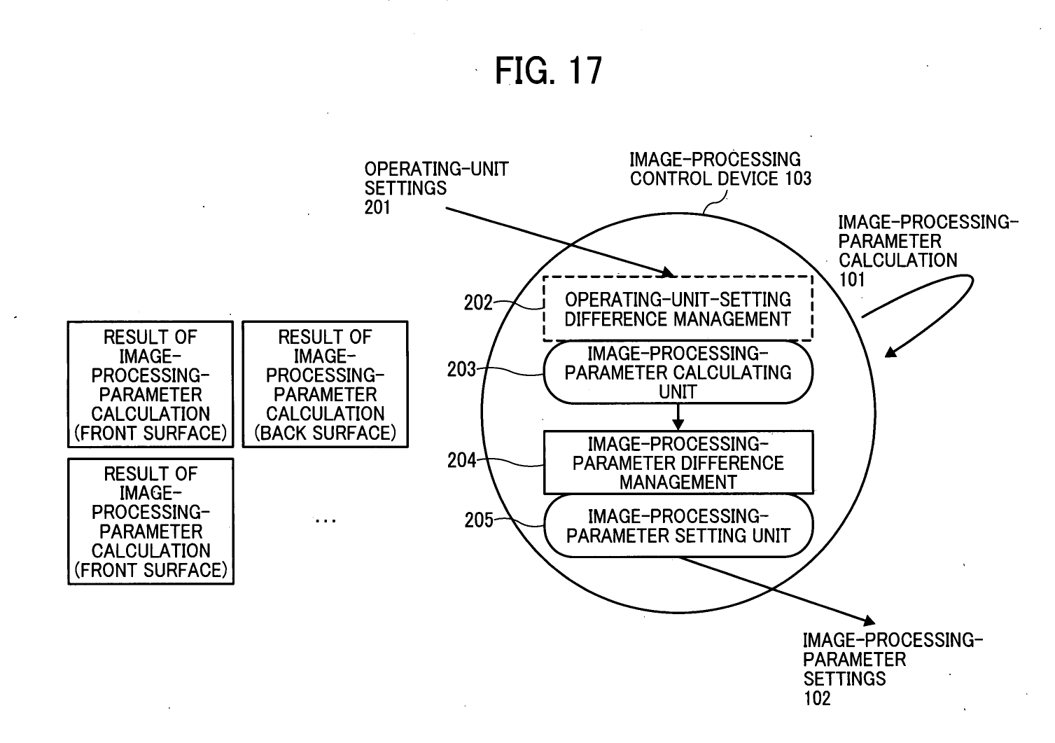

FIG. 17 is a schematic diagram illustrating a method, which is a comparative example of the method illustrated in FIG. 16 and in which efficiency is increased only in the difference management. In this example, during simultaneous duplex scanning, a request for front surface scan, a request for back surface scan, a request for front surface scan, are alternately received via the UI. Because a difference is produced for each scan, it is necessary to perform the image-quality-parameter calculation and the image-quality-parameter setting even when the more efficient difference management is employed. After the parameters have been established, the memory areas are freed.

As described above in detail, the image forming apparatus according to the second embodiment of the present invention has the following advantages (1) and (2).

(1) When a plurality of scanner units perform scanning simultaneously, read image data pieces are alternately transmitted, causing the difference to be produced at each scan, thereby disadvantageously reducing productivity. To this end, the image forming apparatus according to the second embodiment preserves results of image-processing-parameter calculations and information about settings established via the operating unit for each of the scanner units. By preserving the image-processing-parameter results on a scanner-unit-by-scanner-unit basis of only the first sheet of plurality of sheets and utilizing the preserved image-processing-parameter calculation results of the first sheet as image-processing parameters of the second and subsequent sheets rather than calculating the image-processing parameters of the second and subsequent sheets, high productivity in simultaneous scanning can be achieved.

(2) The image forming apparatus includes a difference managing unit for the image-processing-parameter calculating unit 203 and another difference managing unit for the image-processing-parameter setting unit 205 so as to perform the difference management at two stages. This allows to adapt to an addition of an image-processing correction unit only by changing the difference management unit for image-processing-parameter settings. When a plurality of scanner units perform scanning simultaneously, results of image-processing-parameter calculation and information about settings established via the operating unit for each of the scanner units. The image-processing-parameter results of only the first sheet of plurality of sheets are preserved on a scanner-unit-by-scanner-unit basis. Only when a difference is found between results of image-processing-parameter calculation performed for a plurality of scanning units in the difference management performed by the image-processing-parameter setting unit 205, image-processing-parameter settings are established. Meanwhile, image-processing-parameter results of the second and subsequent sheets of the sheets for the plurality of scanning units are the same as those of the first sheet. Because the scanner units individually correspond to different image-processing blocks in the hardware 407, a difference related to the image-processing-parameter setting unit is not produced. This eliminates the need of re-establishing the image-processing parameters, thereby achieving high productivity.

According to an aspect of the present invention, an image forming apparatus includes an operating unit, a plurality of scanner units each obtaining image data by scanning, an image processing unit that is capable of adjusting reading characteristics by correcting the image data fed from the scanner units, and an image-processing control unit. The image-processing control unit includes an image-processing-parameter calculating unit that calculates image-processing parameters according to settings established via the operating unit to output a calculation result, and an image-processing-parameter setting unit that sets the calculation result as image-processing parameters of the image processing unit. The image forming apparatus achieves improvement in productivity by reducing an amount of computations performed by the image-processing-parameter calculating unit.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image forming apparatus comprising:
an operating unit;
a plurality of scanner units each obtaining image data by scanning;
an image processing unit capable of adjusting reading characteristics by correcting the image data fed from the scanner units;
an image-processing control unit, the image-processing control unit including:
an image-processing-parameter calculating unit that calculates an image-processing parameter according to settings entered via the operating unit to output a calculation result;
an image-processing-parameter storing unit that stores the calculation result; and
an image-processing-parameter setting unit that sets the image-processing parameter stored in the image-processing-parameter storing unit as an image-processing parameter of the image processing unit; and
a difference-in-setting determining unit that makes a determination as to whether there is difference between previous settings and current settings established via the operating unit, wherein
the image-processing-parameter calculating unit includes a first calculating unit that calculates the image-processing parameter when the difference-in-setting determining unit has determined that there is the difference.

2. The image forming apparatus according to claim 1, wherein the image-processing-parameter setting unit sets the image-processing parameter only when the image-processing-parameter calculating unit has calculated the image-processing parameter.

3. The image forming apparatus according to claim 1, wherein the difference-in-setting determining unit is capable of making the determination on an application-by-application basis.

4. The image forming apparatus according to claim 1, further comprising:
a read-time storing unit that stores read time values each indicating time when one of the scanner units has scanned a reference chart; and
a time-difference determining unit that determines whether there is difference in the read time values stored in the read-time storing unit, wherein
the image-processing-parameter calculating unit includes a second calculating unit that calculates the image-processing parameter when the time-difference determining unit has determined that there is the difference.

5. The image forming apparatus according to claim 1, further comprising a mode-determining unit that determines whether an operating mode of the apparatus is service mode, wherein
the image-processing-parameter calculating unit includes a third calculating unit that calculates the image-processing parameter when the mode-determining unit has determined that the apparatus is the service mode.

6. The image forming apparatus according to claim 1, further comprising a read-value storing unit that stores reference-chart read values obtained by the scanner units by scanning a reference chart, wherein
the difference-in-setting determining unit makes the determination by determining whether there is difference in one setting of the settings, the one setting being setting of which image-processing parameter varies depending on the reference-chart read value.

7. The image forming apparatus according to claim 1, wherein the image-processing-parameter storing unit stores the calculation result of the image-processing parameter on a scanner-unit-by-scanner-unit basis.

8. The image forming apparatus according to claim 1, wherein the image processing unit includes a plurality of image processing units provided for each of the scanner units.

9. A method for setting an image-processing parameter of an image processing unit in an image forming apparatus that includes an operating unit, a plurality of scanner units each obtaining image data by scanning, and the image processing unit capable of adjusting reading characteristics by correcting the image data fed from the scanner units, the method comprising:
calculating an image-processing parameter according to settings established via the operating unit to output a calculation result;
setting the calculation result as an image-processing parameter of the image processing unit;
making determination as to whether there is difference between previous settings and current settings established via the operating unit, wherein
the calculating is performed when the making determination has determined that there is the difference.

10. A computer program product comprising a computer-usable medium having computer-readable program codes embodied in the medium for setting an image-processing parameter of an image processing unit in an image forming apparatus that includes an operating unit, a plurality of scanner units each obtaining image data by scanning, and the image processing unit capable of adjusting reading characteristics by correcting the image data fed from the scanner units, the program codes when executed causing a computer to execute:
calculating an image-processing parameter according to settings established via the operating unit to output a calculation result;
setting the calculation result as an image-processing parameter of the image processing unit;
making determination as to whether there is difference between previous settings and current settings established via the operating unit, wherein
the calculating is performed when the making determination has determined that there is the difference.
